(19) United States
(12) Patent Application Publication
(10) Pub. No.: US 2010/0059529 A1
(43) Pub. Date: Mar. 11, 2010

(54) FLEXIBLE PACKAGING MADE FROM PLASTIC

(76) Inventors: Jacques Thomasset, Vouvry (CH); Gerhard Keller, Vouvry (CH); Hugues-Vincent Roy, Vouvry (CH); Joachim Pellissier, Vouvry (CH)

Correspondence Address: NIXON & VANDERHYE, PC, 901 NORTH GLEBE ROAD, 11TH FLOOR, ARLINGTON, VA, 22203, US

(21) Appl. No.: 12/300,730

(22) PCT Filed: May 15, 2007
(86) PCT No.: PCT/IB2007/051852

§ 371 Date: Jan. 30, 2009

(30) Foreign Application Priority Data
Jun. 1, 2006 (EP) 06114847.4

(51) Int. Cl. B65D 35/00; B65D 35/10; B29C 53/56

(52) U.S. Cl. 220/613; 220/639; 222/107; 222/106; 493/303; 493/308

(57) ABSTRACT

The invention relates to a plastic package for liquid or viscous products comprising three separate elements, namely a flexible cylindrical side wall formed by a sheet wrapped around a mandrel, an at least partly rigid bottom, and an at least partly rigid top that includes a neck; said package being able to rest on said bottom and having a height H and a diameter D such that the ratio H:D is between 1:1 and 5:1; the side wall and the other two elements, during their assembly, are in contact with a mandrel positioned inside the package.

The invention also relates to a process for the manufacture of a package as described above.

### FIELD OF THE INVENTION

The field of the present invention is plastic packages basically consisting of three prefabricated elements, namely a side wall forming a tubular body in between a semi-rigid bottom and a rigid neck. These packages make it possible to ally the functional properties of packages of bottle types with those of flexible pouch types.

The present invention is particularly—but not exclusively—intended for the following uses:
Packaging of food drinks such as fruit juices, vitamin drinks, milk, cold tea, etc.
Packaging of viscous products such as toothpaste, body care creams, pharmaceutical ointments, food products (mayonnaise, ketchup, mustard), etc.
Packaging of technical products such as silicone or mastic.

### STATE OF THE ART

A number of different types of packages correspond to the definition given above.

An example that may be given is the package disclosed in Austrian Patent document AT 293 944 in which a semi-rigid head is welded to a flexible sheet shaped into a cylindrical tube to give a straight flexible pouch. Patent Application EP 1 362 797 also presents a relatively similar package in which the body of the container may have semi-rigid components attached to either end.

The packages of the prior art certainly offer many advantages, but their production is not easy in practice. Producing flexible packages that will behave as required when in use throws up a number of difficulties, mostly to do with poor rigidity and inconsistency (great variation in mechanical and geometrical properties). For example, the following points are critical when producing the package: optimization of wall thicknesses, empty palletization, transport on production lines, filling, closing, palletization after filling, etc.

When it comes to the use of the package, other critical points demand consideration, particularly: stability of the package when the package is stood on its bottom (flexible packages are often not perfectly upright) opening it without the danger of product accidentally escaping, package recloseability, etc.

Most of these critical points are due to the difficulty of producing flexible packages with sufficient mechanical stiffness.

### GENERAL STATEMENT OF THE INVENTION

It is a particular object of the present invention to overcome the abovementioned problems.

To this end, the invention relates to a plastic package for liquid or viscous products comprising three separate elements, namely a flexible cylindrical side wall formed by a sheet wrapped around a mandrel, an at least partly rigid bottom, and an at least partly rigid top that includes a neck; said package being able to rest on said bottom and having a height H and a diameter D such that the ratio H:D is between 1:1 and 5:1; the side wall and/or the other two elements being in contact with a mandrel during their assembly.

Other particularly advantageous embodiments of the invention are described in the dependent claims.

It should be pointed out that the package according to the invention offers numerous improvements over the prior art (stability, mechanical strength, etc.) owing to the fact that its components, during their assembly, are in contact with a mandrel.

In the absence of such support, it is impossible to produce a package of such good quality.

### DETAILED STATEMENT OF THE INVENTION

The invention is described in more detail below using examples illustrated in the following figures:

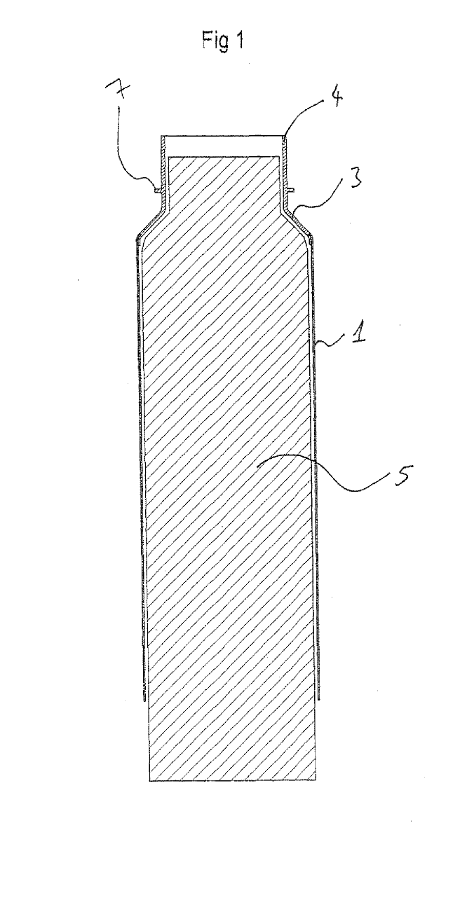

FIG. 1 shows the fixing of the top to the side wall

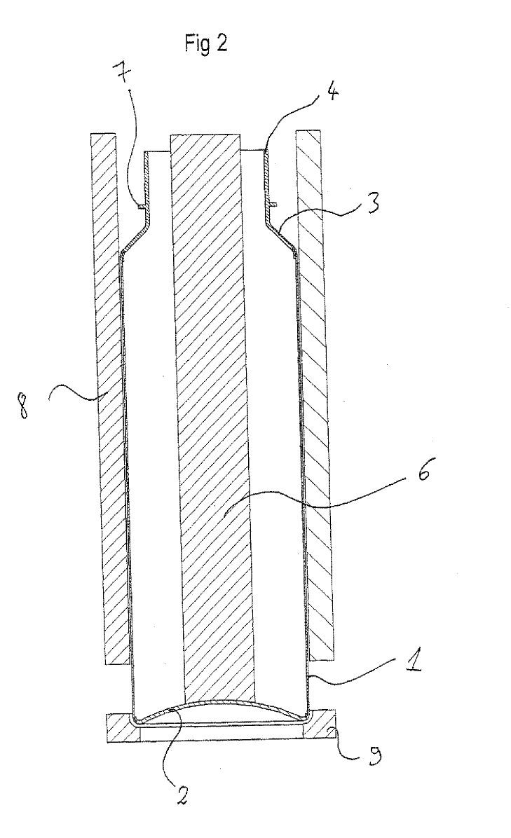

FIG. 2 shows the fixing of the bottom to the side wall

### LIST OF REFERENCE NUMBERS USED IN THE FIGURES

1) Side wall
2) Bottom
3) Top
4) Neck
5) 1^{st} mandrel
6) 2^{nd} mandrel
7) Collar
8) Support cylinder
9) Support ring

The package shown in FIGS. 1 and 2 comprises a side wall 1 consisting of a wrapped laminated sheet, a bottom 2 and a top 3, both the latter being fixed to the side wall 1.

The top 3 is preferably rigid whereas the bottom 2 is made of a plastic that is preferably semi-rigid.

On the neck 4 of the package is a rigid collar 7 used for handling purposes when the tube is being moved about before or after assembly of its component elements.

To fix the top 3 to the side wall 1 (FIG. 1), a mandrel 5 is first brought into contact with the two elements 1, 3.

Similarly (FIG. 2), to fix the bottom 2 to the side wall 1, a mandrel 6 is first placed in contact with the centre of the bottom 2.

The package is also held in place by means of a support cylinder 8 and a support ring 9.

The use of mandrels 5, 6 inside the package when the top 3 and the bottom 2 are being welded to the side wall 1 is of great importance for at least two reasons:
1) highly precise positioning of the elements 1-3 with respect to each other, thus ensuring the reproducible manufacture of quality packages which standard properly upright on their bottom;
2) application of an even and constant force during the welding operation, thus producing quality welds.

The diameters of the mandrels 5, 6 must be less than or equal to the diameter of the side wall 1. The mandrels are advantageously inserted to a distance approximately equivalent to the height of the side wall. The length is therefore preferably at least equal to the height of the side wall. Also preferably, they must have the largest possible diameter in order to ensure precise positioning and, most importantly, the greatest possible force during welding operations because, given that the welding zone between the top 3 (or the bottom 2) and the side wall 1 runs around the outer perimeter of the piece 3 (or 2), it is therefore preferable, during the welding operation, to apply the pressure through the mandrel 5 (or 6) as close as possible to this welding zone.

As regards welding the top 3 to the side wall 1, the mandrel 5 may advantageously have a diameter equal to the diameter of the side wall 1 because the lower edge of the side wall is not attached to anything.

By contrast, when welding the bottom 2, the mandrel 6 has a diameter determined by the opening of the neck 4. It is preferable to use a mandrel whose diameter is marginally less than the dimension of the neck 4 opening.

In another method of manufacture according to the invention, the bottom 2 is first welded to the side wall with the help of a first mandrel whose diameter is equal to the diameter of the side wall. In this case, the bottom must include an opening in order for it to be possible to weld the top 3 to the cylindrical part with the help of a second mandrel inserted through the bottom opening (the diameter of this second mandrel will be less than that of the opening). The final step will be to weld a cap or rigid piece to the bottom 2 to close the opening at the bottom.

The package according to the present invention has the advantage of using only the minimum amount of material necessary to perform its function; that is to say that at each point the amount of material used (and therefore the thickness of the walls at this point) is optimized. Most of the package is made up of the cylindrical side wall 1 which is a thin flexible sheet. This wall 1 must protect the packaged product from the outside and can act as a substrate for graphic and textural decoration. From the mechanical point of view this wall 1 must have sufficient rigidity not to deform under the weight of the product. The ends (the top 3 and the bottom 2) give the package its rigidity and strength, and are at least partly rigid because their walls are thicker. The bottom 2 must be such that the package is stable when stood upright. The neck 4 can take a removable closure system such as a screw top or snap-on top or a welded-on seal. For easy manipulation of the closure system, the neck 4 needs to have a degree of rigidity. The neck 4 is also used to fill the package after manufacture. One advantage of the present invention is that it gives the package the necessary mechanical rigidity for filling in the form of a collar 7 integral with the neck 4. The collar 7 enables the package to be manipulated on the filling machine and allows the neck 4 to be kept still when the closure system is being put on it. To provide a good purchase on the neck 4, it is preferable to have a collar 7 of width greater than 2 mm and thickness greater than 1 mm. These elements are typically made of plastic, examples being polyolefins (PE or PP). These elements may be single-layer or multilayer and are produced by, among other processes, injection moulding, compression moulding or thermoforming. To ensure that their mechanical properties are good enough to produce a high-quality package, these elements preferably have at least locally a thickness of greater than or equal to 1 mm.

Additionally, a flexible-walled package according to the present invention has the advantage that it can be made with preprinted laminated sheets for the walls. These sheets are usually produced by laminating extruded (or coextruded) films and/or blown films. These sheets comprise welding films which are normally polyolefins (PE or PP) and may also comprise functional films to improve the mechanical properties (OPP, PET, PA, PS, etc.) and barrier properties (PET, EVOH, PVDC, SiOx, AlOx, aluminium, etc.). The advantage with these laminated sheets is that they can be printed flat before making up the package and, importantly, that they result in flexible walls of very small thickness (between 100 and 400 microns) and that are very uniform (with thickness variations of less than 10 microns). The thinness and consistency of thickness of the flexible wall makes for a package having a low cost in terms of materials and yet of consistent quality.

1. Plastic package for liquid or viscous products comprising three separate elements, namely a flexible cylindrical side wall (1) formed by a sheet wrapped around a mandrel, an at least partly rigid bottom (2), and an at least partly rigid top (3) that includes a neck (4); said package being able to rest on said bottom (2) and having a height H and a diameter D such that the ratio H:D is between 1:1 and 5:1; characterized in that it is produced by a process in which the side wall (1) and/or the other two elements (2, 3), during their assembly, are in contact with a mandrel (5, 6) positioned inside the package.

2. Package according to claim 1, in which the side wall (1) forms an angle with the bottom of between 89 degrees and 91 degrees.

3. Package according to claim 1, comprising handling means (7) on said neck (4).

4. Package according to claim 3, in which said handling means are a collar (7) integral with said neck (4), its width greater than 2 mm and thickness greater than 1 mm.

5. Package according to claim 1, in which at least 95% of said side wall (1) is of a constant thickness of between 100 and 400 microns; the variation in said thickness being less than approximately 10 microns.

6. Package according to claim 1, in which the bottom (2) and the top (3) have at least locally a thickness greater than or equal to 1 mm.

7. Process for the manufacture of a package as defined in claim 1, characterized in that the side wall (1), bottom (2) and the top (3), during their assembly, are in contact with a mandrel (5, 6) positioned inside the package.
